(19) United States
(12) Patent Application Publication
(10) Pub. No.: US 2021/0316931 A1
(43) Pub. Date: Oct. 14, 2021

(54) DEVICE AND METHOD FOR MIXING A FIRST AND A SECOND AGROCHEMICAL COMPONENT

(71) Applicant: BASF SE, Ludwigshafen (DE)

(72) Inventors: Harald Kroeger, Limburgerhof (DE); Heinz-Gerd Wegkamp, Limburgerhof (DE); Wolf-Dieter Wichmann, Neetzow (DE)

(21) Appl. No.: 17/259,588

(22) PCT Filed: Jul. 18, 2019
(86) PCT No.: PCT/EP2019/069429

§ 371 Date: Jan. 12, 2021

(30) Foreign Application Priority Data
Jul. 18, 2018 (EP) 18184281.6

(51) Int. Cl. B65D 81/32; B01F 15/02

(52) U.S. Cl. CPC B65D 81/3222; B01F 15/0206; B01F 2215/0009; B01F 15/0238; B01F 15/0212

(57) ABSTRACT

The present invention relates to an apparatus for mixing a first (8) and a second agrochemical component (6). The apparatus comprises at least one first vessel (4) for accommodating the first component (8) and one second vessel (5) for accommodating the second component (6), the first (4) and the second vessel (5) being delimited with respect to one another by a connecting region such that the connecting region, in a closed basic state, does not permit a passage of compounds from the second into the first vessel and, in an open state, permits the passage of compounds. Here, the connecting region has a predetermined breaking point (7) formed such that it is intact in the closed basic state and such that it breaks open, causing the connecting region to adopt the open state, when a pressure above a certain threshold pressure is applied. Here, the second vessel has a fluid inlet (1) through which a pressurized fluid is introducible such that pressure can be applied to the predetermined breaking point (7) by the introducible fluid. The invention also relates to a system and a method for mixing a first (8) and a second agrochemical component (6).

The present invention relates to an apparatus, a system and a method for mixing a first and a second agrochemical component.

Agrochemical compounds, which are used for example as crop protection products or fertilizers, commonly exhibit limited storability or are reactive to different degrees. One way of making it possible to use these without problems may consist in storing multiple components separately from one another, and mixing them with one another only shortly before or upon the use thereof.

For example, in the case of crop protection, preparations exist which are composed of multiple chemical constituents which remain stable not over an unlimited period of time, and which then no longer impart their intended action. In this sector, too, there are preparations which have for example a powder consistency and which, after being introduced into a carrier liquid, have the tendency to separate from the latter again, or to settle.

For example, vessels are known which can accommodate multiple media separately from one another in the interior thereof, or which are equipped with an apparatus which permits dosing of the content.

However, if it is sought for the different components to be stored and shipped together in one vessel separately from one another or separately from a carrier liquid, for example in a multi-component pack, there is the problem of bringing the components together, and mixing them, before their use.

The present invention is based on the object of providing an apparatus which not only permits the storage and shipping of different components separately from one another, but by means of which the components can also be reliably mixed.

According to the invention, said object is achieved by means of an apparatus having the features of claim 1, a system having the features of claim 11, and a method having the features of claim 13. Advantageous developments and refinements will emerge from the dependent claims.

The apparatus according to the invention for mixing a first and a second agrochemical component comprises at least one first vessel for accommodating the first component and one second vessel for accommodating the second component. Here, the first and the second vessel are delimited with respect to one another by a connecting region such that the connecting region, in a closed basic state, does not permit a passage of compounds from the second into the first vessel and, in an open state, permits the passage of compounds. The connecting region has a predetermined breaking point formed such that it is intact in the closed basic state and such that it breaks open, causing the connecting region to adopt the open state, when a pressure above a certain threshold pressure is applied. Here, the second vessel has a fluid inlet through which a pressurized fluid is introducible such that pressure can be applied to the predetermined breaking point by the introducible fluid.

The components are thus advantageously separated from one another for as long as the predetermined breaking point is intact. It is thus possible for different media and components to be stored separately from one another. However, if the pressurized fluid is introduced, then an opening is formed in the wall of the second vessel at the predetermined breaking point which breaks open, such that the fluid can pass into the first vessel. This in particular also allows the second component to pass into the first vessel or, conversely, allows the first component to pass into the second vessel. Furthermore, the second component may be flushed with the fluid into the first vessel. In this way, the components can be brought into contact with one another such that a mixture is formed which can then be optionally used or processed further.

By means of the introduction of the fluid under pressure, rigorous thorough mixing can furthermore advantageously be ensured. The components are furthermore mixed in a clearly delimited space, thus reducing the risk of a user having to handle, and come into contact with, components which are possibly problematic with regard to health.

Furthermore, the point in time at which the mixing occurs can be exactly predefined. In particular, in the case of an apparatus with more than two chambers, it is correspondingly possible for multiple components to be mixed in a predefined sequence, wherein, in particular, by means of suitable actuation, it is also possible for a predefined time interval to be adhered to.

The vessels may, in a manner known per se, be formed with in each case at least one wall and with an internal cavity enclosed by said wall. Use is made of materials known per se, for example plastic or metal. Said vessels are not necessarily formed as separate parts, but rather may be formed in one piece, for example as separate chambers of an integral container. In any case, there is at least one region of the wall of the second vessel which simultaneously delimits the cavity in the first vessel and the cavity in the second vessel, such that an opening in said region allows a fluid to pass between the vessels. This is therefore a connecting region. The vessels may be directly adjacent to one another here. They may on the other hand also be arranged such that one vessel is at least partially accommodated by the other, that is to say at least one region of a wall of one vessel is arranged in the interior of the other vessel.

In one embodiment of the invention, the second vessel is at least partially accommodated by the first vessel. Here, the second vessel is in particular arranged such that the cavity that it encloses is at least partially surrounded by the first vessel. This advantageously permits a particularly compact design. In particular, the second vessel may be entirely accommodated by the first vessel.

The vessels are arranged with the connecting region and the predetermined breaking point in particular such that, in the open state of the connecting region, it is made possible for the introducible fluid to pass directly into the first vessel. Here, the fluid thus passes from the second vessel through the connecting region directly into the first vessel.

The second vessel may be designed as a cartridge. It may furthermore be designed with any desired shape, wherein, in particular, an elongate, approximately cylindrical form is provided.

Provision may furthermore be made whereby, for the assembly of the apparatus according to the invention, the second vessel is insertable through a suitably designed opening which is formed in a wall of the first vessel. In this way, the vessels can be stored or marketed separately from one another, and the apparatus is obtained as desired by inserting the second vessel into the first vessel. Here, the vessels are in particular connected to one another such that a seal is realized for preventing a permeation of the fluid. Said seal is designed so as to withstand the pressure that arises during the introduction of the pressurized fluid in the first vessel.

The first and/or the second component may be in the form of a powder, granulate or liquid. Furthermore, a gaseous compound may be provided. The components may furthermore themselves comprise a mixture of compounds. In this way, it is advantageously possible for entirely different components to be provided for the mixing, which components can be stored in different forms and states.

For example, one component may be present as a solid (powder, granulate etc.), whereas the other component is present in liquid form. The storage of the finished mixture could in this case have an adverse effect on shelf life, or components could become demixed. The apparatus according to the invention is thus particularly advantageous here.

For example, the first vessel may contain a main component of the mixture to be produced, whereas an auxiliary compound is provided in the second vessel.

The introducible fluid is in particular a liquid, wherein the liquid may comprise in particular water and/or an alcohol. In particular, use may be made of a liquid which is suitable as a solvent for the first and/or second component. It is advantageously particularly easily possible for pressure to be applied to a liquid by means of a pump in order to realize, during the introduction into the second vessel, the pressure required for breaking open the predetermined breaking point.

In a further examples, the fluid may be gaseous, for example air, which may be fed for example as compressed air.

The first and/or second component, or the mixture thereof with the fluid, may comprise a pesticide and/or a fertilizer.

In one embodiment of the invention, the fluid is introducible such that the second component can be substantially completely flushed out of the second vessel. Thus, it is advantageously the case that the entirety of the second component provided in the second vessel passes into the first vessel and can be mixed there with the first component.

The apparatus is in particular designed such that substantially complete flushing-out is achieved if the fluid is introduced with a pressure above the certain threshold pressure and if the volume that is introduced exceeds a predefined minimum volume. The minimum volume may for example amount to a multiple of the volume of the second vessel, for example two times or three times the volume of the second vessel.

Furthermore, the apparatus may be formed such that the threshold pressure is high enough to ensure that the fluid is introduced with such a high pressure that the second component is flushed out of the second vessel in an efficient manner. The possibly complete flushing-out may furthermore be improved by means of a suitable form of the second vessel and/or a suitable arrangement of the predetermined breaking point.

In a further embodiment, the second vessel has an elongate form, the fluid inlet being arranged at one end in the longitudinal direction, and the predetermined breaking point being arranged at the opposite end of the second vessel. The two ends of the second vessel are in this case defined in particular as ends in the longitudinal direction, for example along a longitudinal axis of the second vessel. In the case of such an elongate form, in the case of which the fluid is introducible at one end and the predetermined breaking point is situated at the other end, the fluid advantageously flows through the entire second vessel and carries the second component with it into the first vessel. The volume enclosed by the second vessel may for example have a cylindrical form, and the fluid can be introduced at one axial end, whereas the predetermined breaking point is arranged at the opposite end.

The first vessel may be equipped with a dosing pump which can also be operated in an agitation or re-homogenization mode. In this way, the components, after they have passed into the first vessel, can be thoroughly mixed in a particularly effective manner. Said dosing pump may be integrally connected to the first vessel, or may be arranged as a separate unit at least partially in the first vessel.

Furthermore, particularly effective thorough mixing in the first vessel may be ensured by means of a suitable design and arrangement of the second vessel and of the predetermined breaking point. For example, the predetermined breaking point may be arranged such that, when the fluid, optionally together with the second component, enters the first vessel from the second vessel, turbulence occurs, or the thorough mixing is promoted in some other manner in terms of fluid mechanics.

In one embodiment of the invention, a wall of the second vessel has, in the region of the predetermined breaking point, a reduced wall thickness in relation to the surrounding area. In this way, the predetermined breaking point can advantageously be produced particularly easily and reproducibly. The predetermined breaking point may additionally or alternatively be formed in some other way by means of a weakening of the wall of the second vessel. Here, it is ensured in particular that the breaking-open of the predetermined breaking point occurs in a controlled manner, and in particular, the opening that is formed in the wall of the second vessel as a result has a particular size. In this way, the fluid mechanics characteristics of the opening, in particular the fluid volume that passes through per unit of time in the presence of a particular pressure, can be determined prior to use.

In a further embodiment, when the threshold pressure is reached, a pressure difference between the first and the second vessel amounts to at least 150 mbar, preferably at least 2 bar. The pressure difference exists here between the two sides of the predetermined breaking point. In this way, it can advantageously be ensured that no unintended pressure fluctuations, for example in the event of changes in temperature, result in a breakthrough of the predetermined breaking point. Furthermore, a minimum required pressure for the flushing-out of the second vessel can be ensured.

In one refinement, the fluid inlet of the second vessel has a coupling unit. This is in particular arranged so as to be easily accessible from the outside, for example for the purposes of connecting a liquid or gas line. In this way, the apparatus can advantageously be configured in a particularly flexible and easily usable manner.

The coupling unit furthermore ensures that the fluid is introducible under pressure in order to thereby apply pressure to the predetermined breaking point. For this purpose, it is for example possible for a seal and a fastening to be provided, to which means for the feed of the fluid can be connected in liquid-tight and/or gas-tight fashion. Use may be made of designs of couplings that are known per se, wherein, for example, a fastening of a feed line by means of screws or by means of a plug-in or detent engagement action by interaction of the coupling unit with a connector of the feed line is provided.

The fluid is in particular fed from a unit external to the apparatus, which unit can be detachably connected to the apparatus, for which purpose, in particular, use is made of the coupling unit and a connector that interacts therewith.

In one embodiment of the invention, the coupling unit has a valve. In this way, it is advantageously possible to prevent the second component from emerging from the second vessel through the fluid inlet in an undesired manner, or, conversely, a compound entering the second vessel in an undesired manner.

The valve may be designed in a variety of ways, in particular as a check valve which in particular permits a passage of a fluid only when this takes place into the second vessel from the outside and at a certain minimum pressure. In this case, the valve may be designed such that the minimum pressure that must be overcome in order to introduce a fluid through the valve lies in the vicinity of the threshold pressure required for breaking open the predetermined breaking point. The minimum pressure for the opening of the valve may amount to approximately at least 50%, preferably 80%, particularly preferably 90%, of the threshold pressure.

In a further embodiment, the coupling unit comprises a diaphragm, for example an elastic diaphragm. This may in particular be formed as part of the valve of the coupling unit, for example in the case of a diaphragm valve. In this way, it is advantageously possible for the introduction of the fluid to take place in a particularly well-controlled manner. The fluid inlet may furthermore be closed by the diaphragm when no fluid is presently being introduced or said fluid has already been introduced.

For example, a diaphragm may be arranged so as to close the fluid inlet. Said diaphragm may furthermore be arranged and designed to at least partially open the fluid inlet when pressure, in particular a pressure above a certain minimum pressure, is applied to said diaphragm from the side averted from the second vessel. The fluid can then pass into the second vessel past the diaphragm or through apertures, which are opened up in this way, within the diaphragm.

In one refinement, the diaphragm has at least one aperture which is formed such that the introducible fluid can be diverted entirely or at least partially in the direction of a wall of the second vessel. In this way, improved flushing-out of the second vessel by the fluid can advantageously be achieved.

The aperture or a multiplicity of apertures may for example be arranged in edge regions of the diaphragm. They may furthermore be formed in the diaphragm so as to predefine a flow direction of the fluid in the direction of the vessel wall.

In a further embodiment of the invention, the coupling unit may comprise a diaphragm which closes the fluid inlet and which must be removed and/or pierced in order for the fluid to be introduced. The fluid inlet is thus permanently opened, and must if necessary be closed again manually.

For example, a diaphragm may be provided which is connected to the coupling unit such that it can be peeled off or detached in some other way. Provision may furthermore be made for the diaphragm to be destroyed during the introduction of the fluid under the pressure of the fluid, wherein, in particular, a further predetermined breaking point may be provided at the diaphragm. Furthermore, the diaphragm may be pierced, torn or cut, or an opening may be produced in the diaphragm by means of some other mechanical action.

In one refinement, the first vessel has an extraction opening. In this way, the mixture formed in the first vessel can advantageously be easily extracted.

The extraction opening may be formed as an outlet, which is equipped in particular with an outlet coupling element which can be connected to an extraction device. In a further example a dosing pump is provided, by means of which the mixture can be conducted through the extraction opening to the outside in a controlled manner.

The system according to the invention of the type mentioned above comprises at least one apparatus according to the invention as per the above description and the patent claims, an introduction apparatus, by means of which the fluid is introducible via the fluid inlet, an extraction apparatus by means of which the mixture of the first and the second agrochemical component can be extracted from the first vessel, and a control unit, by means of which at least one parameter for the introduction of the fluid can be controlled. In this way, the apparatus can be operated in an advantageously simple and reliable manner.

For example, the extraction device may comprise a dosing device by means of which the mixture produced in the first vessel is dispensed during agrotechnical use, or may be connected to such a dosing device. As a dosing device, use may be made for example of a spray pistol, a spraying apparatus or some other appliance for dispensing purposes. The extraction of the mixture from the first vessel and optionally the dosing and dispensing can be accurately controlled by means of the extraction apparatus.

Here, the control unit can introduce the fluid into the apparatus on the basis of the parameter such that the mixture is forced out by the fluid. The extraction of the mixture from the first vessel can thus also be controlled on the basis of the parameter for the introduction of the fluid.

In one embodiment of the system according to the invention, the parameter for the introduction of the fluid comprises a magnitude of the pressure applied to the introducible fluid, a duration, a point in time, a flow speed and/or a fluid volume. This advantageously permits the control of the system on the basis of particularly relevant parameters for the use of the apparatus.

The system may for example comprise a holder for the apparatus, for example in order to ensure a preferred orientation. For example, the apparatus may be oriented such that the extraction apparatus points upward in the Earth's gravitational field, in order to prevent any solids that may settle from entering the extraction apparatus. By means of the holder, it can furthermore be ensured that the operation of the system by means of the apparatus is particularly easily and reliably possible.

The control unit may control the parameter for the introduction of the fluid such that complete flushing-out of the second vessel is ensured. In particular, for this purpose, the pressure of the introduced fluid that is used, and a minimum introduced volume, may be predefined. Furthermore, the flow speed of the fluid may be controlled.

The system may furthermore comprise a mixing apparatus by means of which the material extracted from the first vessel, in particular the mixture that has been formed there, can be mixed with a further component, in particular in liquid form.

The method according to the invention of the type mentioned in the introduction comprises the following steps: providing at least one first vessel for accommodating the first component and a second vessel for accommodating the second component, the first and the second vessel being delimited with respect to one another by a connecting region such that the connecting region, in a closed basic state, does not permit a passage of compounds from the second into the first vessel and, in an open state, permits the passage of compounds. Here, the connecting region has a predetermined breaking point formed such that it is intact in the closed basic state and such that it breaks open, causing the connecting region to adopt the open state, when a pressure above a certain threshold pressure is applied. A fluid is introduced into the second vessel through a fluid inlet of the second vessel such that pressure is applied to the predetermined breaking point by the introduced fluid.

The method according to the invention is in particular configured to operate the above-described apparatus according to the invention and the above-described system according to the invention. The method thus has the same advantages as the apparatus and the system.

In one embodiment of the method, the first and/or the second component is in the form of a powder, granulate or liquid. In this way, components present in different form can advantageously be stored and shipped separately, in order to be mixed, and brought into a form ready for use, directly before being used.

In a further embodiment, the introduced fluid is a liquid, the liquid comprising in particular water and/or an alcohol. This advantageously permits the use of particularly suitable fluids for the agrochemical components to be mixed. In particular, the fluid is suitable as a solvent for the first and/or second component.

In particular, the first component, the second component and/or a mixture of the first and the second component comprise(s) a pesticide and/or a fertilizer. Furthermore, the mixture of the first and the second component may comprise a composition that can be used as a pesticide and/or fertilizer.

The invention will now be discussed on the basis of examples with reference to the drawings.

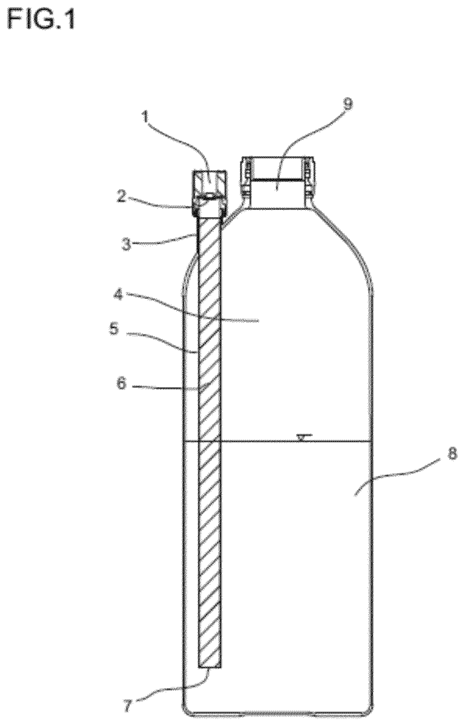

FIG. 1 shows an example of the apparatus according to the invention,

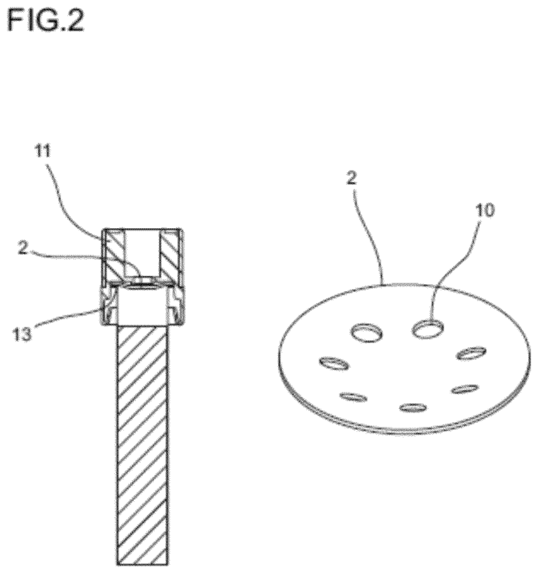

FIG. 2 shows enlarged views of the inlet region of the apparatus according to the invention and of a diaphragm used therein,

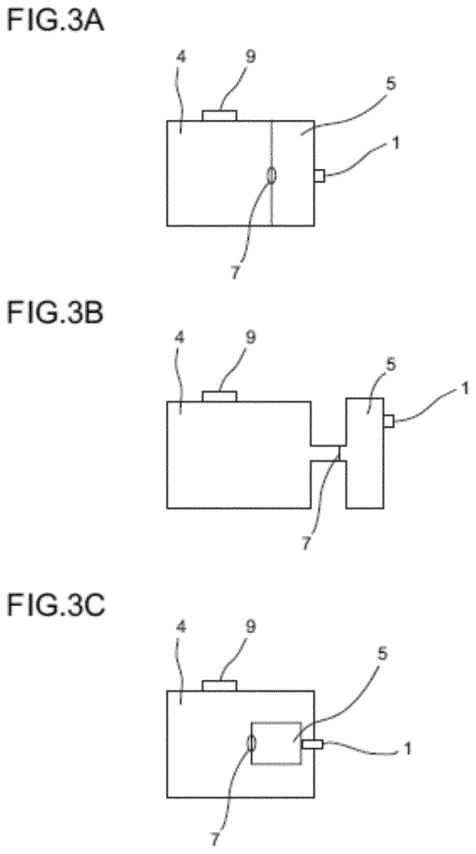

FIGS. 3A, 3B and 3C show the basic construction of further examples of the apparatus according to the invention, and

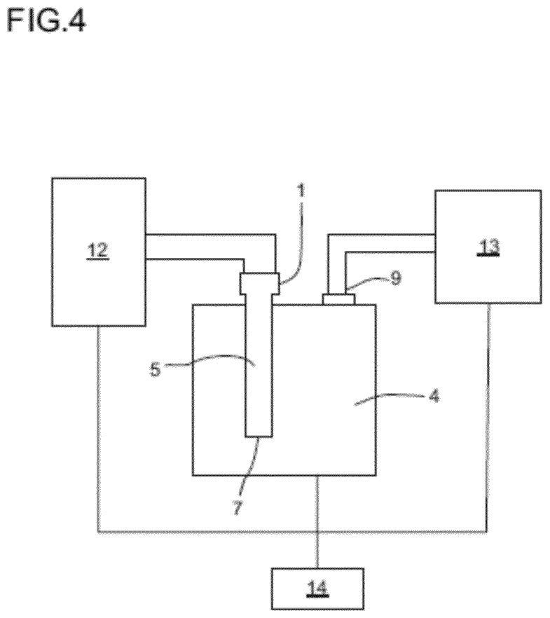

FIG. 4 shows an example of the system according to the invention.

A first example of the apparatus according to the invention, and the method according to the invention, will be discussed with reference to FIG. 1.

The apparatus comprises a first vessel 4 and a second vessel 5. Here, a first component 8, for example a main constituent 8 of a mixture to be realized, is situated in the first vessel 4. The first vessel 4 has an extraction opening 9 and a further opening 3, which is designed as a receptacle for a second vessel 5 which projects into the first vessel 4.

For the purposes of the present description, “in the first vessel 4” means that a component or an element of the apparatus is situated within the cavity formed by the first vessel 4, wherein this excludes the space occupied by the second vessel 5.

In the example illustrated, the second vessel 5 is integrally connected to the first vessel 4. In a further example, the opening 3 is designed such that the connection between the first 4 and the second vessel 5 is detachable. In particular, the first vessel 4 can in this case be reused after use, for example by being refilled with the first component 8 and a new second vessel 5 being inserted in fluid-tight fashion into the opening 3.

In this example, the second vessel 5 is designed as a cartridge 5 and has a substantially cylindrical form. At that end which projects out of the first vessel 4 in an axial direction, there is provided a coupling unit 1 which is in particular arranged so as to be easily accessible to a user from the outside. At this end, the second vessel 5 is closed by means of a diaphragm 2, which is designed as part of a valve device which permits the passage of a fluid only when a higher pressure prevails outside the second vessel 5 than inside the latter. In a closed basic state, the wall of the second vessel 5, in particular that part of the second vessel 5 which projects into the first vessel 4, is closed, and a passage of material from the second 5 into the first vessel 4 is not possible.

A second component 6 is situated in the second vessel 5. The first component 8 and the second component 6 may be present in different forms. They may in particular be in liquid or solid, for example powder or granulate, form. Furthermore, the components 6, 8 may be present in different forms in relation to one another. For example, the second component 6 may be provided as a granulate, and the first component 8 may be provided in liquid form.

The second vessel 5 furthermore has a predetermined breaking point 7 at a position which is situated within the first vessel 4, in this case at that axial end of the second vessel 5 which is situated in the first vessel 4. In the example illustrated, this is a region in which the wall thickness of the second vessel 5 is locally reduced. The predetermined breaking point 7 may be formed in different ways that are known per se, for example by means of a weakening of the wall in the region by means of other methods and modifications of the wall material. Furthermore, the predetermined breaking point 7 may assume different forms, for example a region weakened in punctiform fashion, by means of a circular or elongate region, or by means of multiple intersecting elongate regions.

The predetermined breaking point 7 is formed such that it breaks open when a pressure above a certain threshold pressure is applied. A connecting region between the second 5 and the first vessel 4 is formed, in which material can pass between the vessels 4, 5. The predetermined breaking point 7 is in particular formed such that the opening that is formed has a reproducible and predetermined shape, for example in the form of a circular opening, the form and size of which are substantially predictable. In a further example, the predetermined breaking point 7 may be formed such that, as it breaks open, a major part of that wall of the second vessel 5 which projects into the first vessel 4 is opened, for example in order to produce as large as possible an opening for the rapid release of the second component 6 into the first vessel 4.

If a fluid, for example water, is conducted at adequate pressure into the cartridges from the outside via the coupling unit, then pressure is also applied to the predetermined breaking point 7. Here, if the threshold pressure is exceeded, the predetermined breaking point 7 breaks open. The fluid passes through the second vessel 5 and is forced through the broken-open connecting region into the first vessel 4. Here, the second component 6 is also flushed out of the second vessel 5 and passes into the first vessel 4. In this way, the first 8 and the second component 6 are merged, wherein the point in time for this is predefined by the introduction of the fluid from the outside.

In further examples, multiple vessels formed in the manner of the second vessel 5 are provided, which may each have separate coupling units or else coupling units which are common to several of said vessels. In this way, it is possible for multiple different components to be merged and mixed with the first component 8 or with the mixture that has formed in the first vessel 4.

In a further example, the first vessel 4 comprises a dosing pump. By means of this dosing pump, in an agitation mode, the material situated in the first vessel 4 can be reliably mixed. For this purpose, the dosing pump can for example circulate the content of the first vessel 4 such that mixing takes place.

In the example, it is furthermore the case that the interior of the second vessel 5 is flushed and washed out as a result of the fluid being introduced. This takes place by virtue of the fluid being introduced with such a speed that, in terms of fluid mechanics, the second component 6 passes together with the fluid into the first vessel 4. Provision may furthermore be made for the interior of the second vessel 5 to be flushed and cleaned by virtue of the fluid being introduced in a manner specifically suited to this purpose.

With reference to FIG. 2, enlarged views of the inlet region of the apparatus according to the invention and of a diaphragm 2 used therein will be discussed.

To securely close the second vessel 5 in the direction of the coupling unit 1, the diaphragm 2 is arranged such that it is tensioned and, by means of said tension, closes an opening in the direction of the coupling unit 1. For this purpose, the diaphragm 2 may for example be clamped between the second vessel 5 and a coupling cover 11, and close an opening formed in the latter. The diaphragm 2 has apertures 10 through which the fed fluid can be introduced from the coupling into the second vessel 5 if the pressure on the side of the coupling outside the second vessel 5 is higher than that within the second vessel 5. In particular, a minimum pressure is provided which must be exceeded in order that the fluid can pass the diaphragm 2. Said minimum pressure is, in the example, thus lower than the threshold pressure required for the breaking-open of the predetermined breaking point 7. In this case, it amounts to 80% of the threshold pressure. In further examples, the minimum pressure for the opening of the valve amounts to at least 50%, at least 80% or at least 90% of the threshold pressure.

The apertures 10 in the diaphragm 2 are, in the example, designed and arranged such that the fluid, when it passes through the apertures 10, is diverted in targeted fashion towards the inner walls of the second vessel 5, in order to realize cleaning and flushing there. In particular, a situation is avoided in which material that has accumulated on the inner wall of the second vessel 5 is not flushed into the first vessel 4.

With reference to FIGS. 3A, 3B and 3C, the basic construction of further examples of the apparatus according to the invention will be discussed.

The examples encompass in each case a first 4 and a second vessel 5, which are connected to one another such that they are, at least at a predetermined breaking point 7, separated from one another only by the wall in which the predetermined breaking point 7 is formed. The first vessel 4 has an extraction opening 9. The second vessel 5 has a coupling unit 1, through which a pressurized fluid can be introduced.

In the situation illustrated in FIG. 3A, the first 4 and the second vessel 5 adjoin one another in the region of a relatively large wall surface in which the predetermined breaking point 7 is formed. In the situation illustrated in FIG. 3B, the two vessels 4, 5 are connected to one another at a small surface, such that the predetermined breaking point 7 occupies substantially the entire region in which said vessels are directly adjacent to one another. In the situation illustrated in FIG. 3C, it is finally the case that the second vessel 5 is arranged almost entirely in the interior of the first vessel 4, and only the coupling unit 1 projects out of said first vessel.

In further examples, other arrangements of the vessels 4, 5 relative to one another are possible.

An example of the system according to the invention will be discussed with reference to FIG. 4.

Here, an apparatus according to the invention having a first vessel 4 and a second vessel 5 is provided, as already described above with reference to FIGS. 1 and 2. The first vessel has an extraction opening 9, and the second vessel 5 has a predetermined breaking point 7 and a coupling unit 1.

In the system, an introduction apparatus 12 is coupled to the coupling unit 1. Furthermore, an extraction apparatus 13 is coupled to the extraction opening 9. The coupling to the introduction apparatus 12 and to the extraction apparatus 13 is realized by means of lines through which compounds, in particular a fluid, can be conducted. Furthermore, a fluid flow with solid components may also be conducted through the lines.

Furthermore, a control unit 14 is provided which is coupled to the apparatus, to the introduction apparatus 12 and to the extraction apparatus 13. Said control unit controls the operation of the system and in particular controls the introduction of a fluid from the introduction apparatus 12 into the second vessel 5. For example, the duration and/or the point in time of the introduction of the fluid can be controlled, and furthermore, the flow speed, the fed fluid volume and/or the pressure applied to the fluid can be predefined.

Here, an interface may also be provided, by which the control unit 14 can be operated by a user, for example through the inputting of particular values or by actuation and triggering of a program for controlling the system.

The pressurized fluid fed through the introduction apparatus 12 may for example be water. Furthermore, use may be made of an alcohol or some other liquid, and of a mixture of different liquids. Alternatively or in addition, a gas, for example air, may be introduced and pressurized.

In the example, the extraction apparatus 13 comprises a unit for dispensing a mixture, which mixture is extracted from the first vessel 4 after the mixing of the main constituent 8 with the second component 6.

### LIST OF REFERENCE DESIGNATIONS

1 Coupling unit; fluid inlet
2 Diaphragm
3 Opening (first vessel)
4 First vessel
5 Second vessel; cartridge
6 Second component
7 Predetermined breaking point
8 First component; main constituent
9 Extraction opening
10 Aperture
11 Coupling cover
12 Introduction apparatus
13 Extraction apparatus
14 Control unit

1. An apparatus for mixing a first agrochemical component and a second agrochemical component, the apparatus comprising:
at least one first vessel for accommodating the first component, and
at least one second vessel for accommodating the second component,
wherein:
the first vessel and the second vessel are delimited with respect to one another by a connecting region such that the connecting region, in a closed basic state, does not permit a passage of compounds from the second vessel into the first vessel and, in an open state, permits the passage of compounds,
the connecting region has a predetermined breaking point formed such that it is intact in the closed basic state and such that it breaks open, causing the connecting region to adopt the open state, when a pressure above a certain threshold pressure is applied, and
the second vessel has a fluid inlet through which a pressurized fluid is introducible such that pressure can be applied to the predetermined breaking point by the introducible fluid.

2. The apparatus according to claim 1, wherein:
the second vessel is at least partially accommodated by the first vessel.

3. The apparatus according to claim 1, wherein:
the second vessel has an elongate form,
the fluid inlet being arranged at one end in a longitudinal direction, and
the predetermined breaking point being arranged at the opposite end of the second vessel.

4. The apparatus according to claim 1, wherein:
a wall of the second vessel has, in the region of the predetermined breaking point, a reduced wall thickness in relation to the surrounding area.

5. The apparatus according to claim 1, wherein:
when the threshold pressure is reached, a pressure difference between the first vessel and the second vessel amounts to at least 150 mbar.

6. The apparatus according to claim 1, wherein:
the fluid inlet of the second vessel has a coupling unit.

7. The apparatus according to claim 6, wherein:
the coupling unit has a valve.

8. The apparatus according to claim 6, wherein:
the coupling unit comprises a diaphragm.

9. The apparatus according to claim 8, wherein:
the diaphragm has at least one aperture which is formed such that the introducible fluid can be diverted at least partially in the direction of a wall of the second vessel.

10. The apparatus according to claim 1, wherein:
the first vessel has an extraction opening.

11. A system for mixing a first agrochemical component and a second agrochemical component, the system comprising:
at least one apparatus according to claim 1;
an introduction apparatus by means of which fluid is introducible via the fluid inlet of the apparatus;
an extraction apparatus by means of which a mixture of the first agrochemical component and the second agrochemical component can be extracted from the first vessel; and
a control unit by means of which at least one parameter for the introduction of the fluid can be controlled.

12. The system according to claim 11, wherein:
the parameter for the introduction of the fluid comprises a magnitude of the pressure applied to the introducible fluid, a duration, a point in time, a flow speed and/or a fluid volume.

13. A method for mixing a first agrochemical component and a second agrochemical component, the method comprising:
providing at least one first vessel for accommodating the first component and a second vessel for accommodating the second component, wherein
the first vessel and the second vessel are delimited with respect to one another by a connecting region such that the connecting region, in a closed basic state, does not permit a passage of compounds from the second vessel into the first vessel and, in an open state, permits the passage of compounds;
the connecting region has a predetermined breaking point formed such that it is intact in the closed basic state and such that it breaks open, causing the connecting region to adopt the open state, when a pressure above a certain threshold pressure is applied; and
introducing a fluid into the second vessel through a fluid inlet of the second vessel such that pressure is applied to the predetermined breaking point by the introduced fluid.

14. The method according to claim 13, wherein:
at least one of the first component and the second component is in the form of a powder, granulate or liquid.

15. The method according to claim 13, wherein:
the introduced fluid is a liquid, the liquid comprising at least one of water and an alcohol.
